(19) United States
(12) Patent Application Publication
(10) Pub. No.: US 2004/0150227 A1
(43) Pub. Date: Aug. 5, 2004

(54) Pipe fitting comprising a body and a nut

(76) Inventor: Hendrik Van Wyk, Capetown (ZA)

Correspondence Address: YOUNG & THOMPSON, 745 SOUTH 23RD STREET 2ND FLOOR, ARLINGTON, VA, 22202

(21) Appl. No.: 10/473,416

(22) PCT Filed: Mar. 26, 2002
(86) PCT No.: PCT/ZA02/00049

(30) Foreign Application Priority Data
Mar. 30, 2001 (ZA) 2001/2615

(51) Int. Cl. F16L 19/04

(52) U.S. Cl. 285/382; 285/382.7

(57) ABSTRACT

A pipe fitting according to the invention comprises a body (1.1) and a nut (2), the body (1.1) having at least one sleeve adapted to snugly receive a pipe end (7) and provided with external threading (14) and a spigot (11), the spigot (11) having at its leading end an external partly tapered forward section (12), and the nut (2) having internal threading which matches the external threading (14) on the sleeve and an internal taper (10) at the far end of the threading, the arrangement of the forward section, tapers and threading being such that when the sleeve and the nut are screwed together the forward section of the spigot (11) comes into contact with the internal taper (10) of the nut and is deflected inwardly to grip a pipe end (7) which is in the sleeve.

### FIELD OF INVENTION

This invention relates to pipe fittings used to connect pipes to one another and to other components of an installation.

### BACKGROUND TO THE INVENTION

Conventional pipe fittings are used to connect pipes to one another and to other components of an installation. In its simplest from such a pipe fitting includes a body with an externally threaded socket into which the pipe end is inserted until it encounters an end stop. Before inserting the pipe end into the socket, the pipe end is passed through an internally threaded nut and a ferrule. Because of its shape a ferrule is often referred to in the plumbing trade as an “olive”. The ferrule encircles the pipe and is against the end of the socket. When the nut is screwed onto the socket and tightened, the olive is crushed against the pipe forming both a seal and a means which grips the pipe and prevents it being pulled out of the socket. The body can have one, two or three or more sockets depending on the intended use. Examples of bodies are a tees, a bend, a coupling and a cross.

FIG. 1 of the drawings illustrates the way in which conventional pipe fittings are used to connect pipes to one another and to other components of an installation. FIG. 1 illustrates 3 possible ways in which water may flow should a leak occur. Arrow 4 shows that water may flow between the pipe and the olive. Arrow 5 shows that water may flow between the body and the olive and then between the olive and the nut. Arrow 6 shows that water may flow between the nut and the body.

Referring to FIG. 2 of the drawings, there is shown a fitting according to an earlier invention by the present inventor. This is shown to illustrate that with that invention there are two possible routes in which water may flow. Usually no water escapes but it is possible that in a few instances leaks may occur. If there is a leak, water may flow as shown by Arrow 9 between the body and the nut, or as shown by Arrow 8 between the pipe and the nut. The earlier invention offers the following advantages inter alia over the prior art:

1. The number of possible escape routes for water is reduced from three to two.

2. There is a considerable reduction in the amount of material needed to manufacture equivalent fittings.

An object of the present invention is to make further improvements on both the above mentioned advantages.

### SUMMARY OF INVENTION

A pipe fitting according to the invention comprises a body and a nut, the body having at least one sleeve adapted to snugly receive a pipe end and provided with external threading and a spigot, the spigot having at its leading end a truncated nose section and an external partly tapered forward section, the angle of the external taper on the forward section of the spigot being between 50° and 80° to a transverse section through the sleeve and the nut having internal threading which matches the external threading on the sleeve and an internal taper at the far end of the threading, the angle of the internal taper on the nut being at least 10° less than that of the external taper and in the range of 50° to 30° to a transverse section through the nut, the arrangement of the forward section, tapers and threading being such that when the sleeve and the nut are screwed together the forward section of the spigot comes into contact with the internal taper of the nut and is deflected inwardly to grip and seal a pipe end which is in the sleeve.

Further in a pipe fitting according to the invention the angle of the external taper on the front section of the spigot is 70° leading to a nose section of 90° and the internal taper on the nut is 45°.

The body in a pipe fitting according to the invention may be a coupling.

The body in a pipe fitting according to the invention may be a tee.

The body in a pipe fitting according to the invention may be a bend.

The body in a pipe fitting according to the invention may be a cross.

Further the invention includes a method of joining pipes in which a pipe is inserted into a pipe fitting according to the invention, and the sleeve and nut are screwed together.

### BRIEF DESCRIPTION OF DRAWINGS

For a better understanding of the present invention, and to show how the same may be carried into effect, reference will now be made by way of example to the accompanying drawings in which:

FIG. 1 is a section through a conventional pipe fitting

FIG. 2 is a section through a pipe fitting according to an earlier invention of the inventor.

FIG. 3 is a section through a coupling body according to the present invention

FIG 4 is a section through a nut used in conjunction with the coupling shown in FIG. 3

FIG. 5 is a detail of the spigot end shown at 11 in FIG. 3

FIG. 6 is a section through a T-body according to the present invention

FIG. 7 is a section through a T-body and nuts illustrating how a pipe is fitted according to the present invention

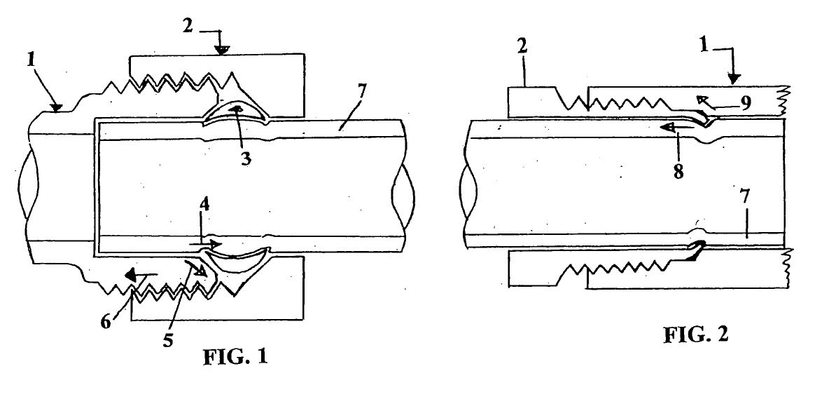

### BEST MODE OF CARRYING OUT THE INVENTION

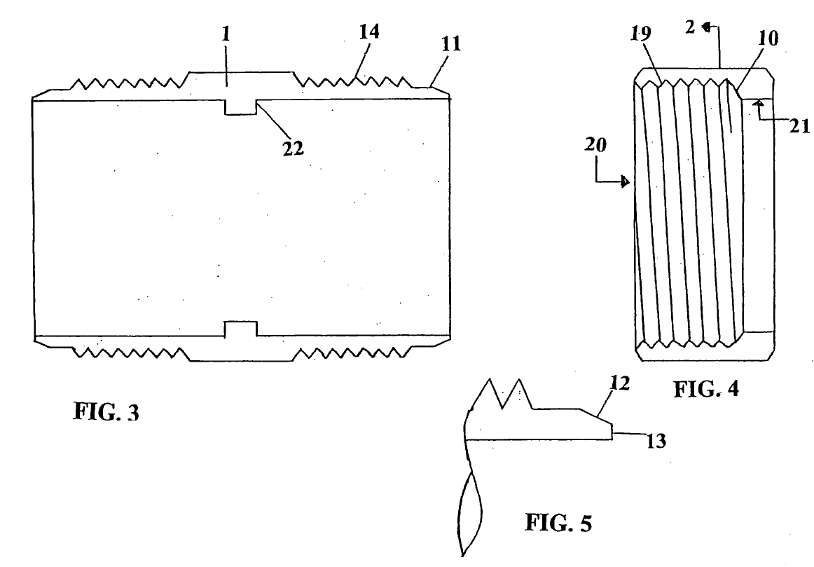

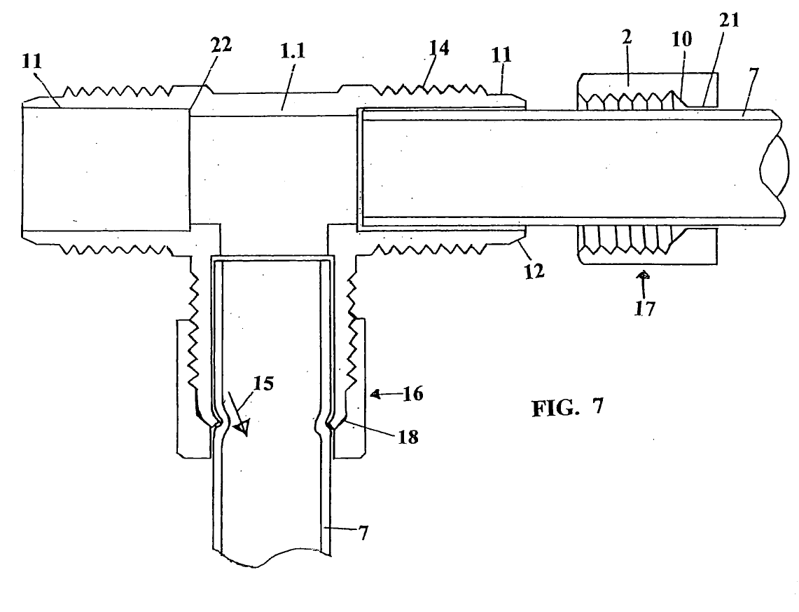

One form of the present invention is a pipe fitting comprising a coupling body 1 shown in FIG. 3 and nut 2 shown in FIG. 4. The coupling body 1 is provided with an external thread 14 and a spigot 11 at both ends. A detail of the spigot 11 is shown in FIGS. 5 The spigot has a taper 12 having an angle of 70° and a 90° nose section 13. An internal stop 22 is provided. The end of a pipe to be fitted will abut against the stop 22 (see FIG. 7).

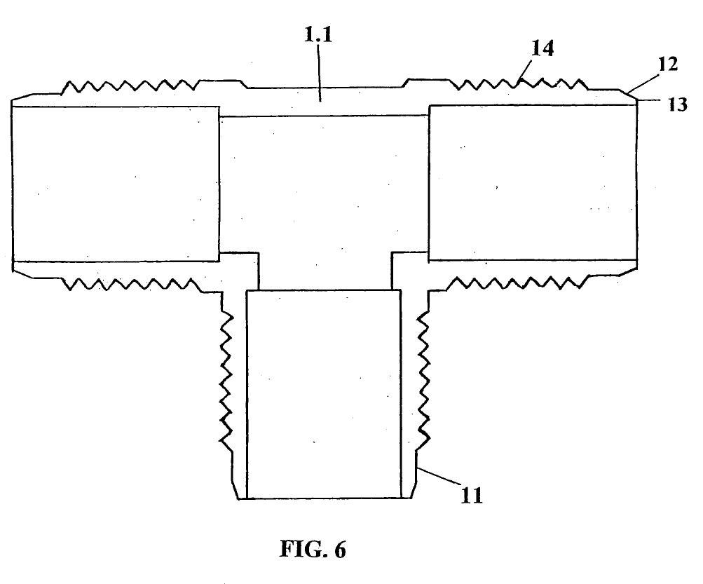

The nut 2 has a sleeve 20 having an internal thread 19 which matches the external thread 14 of the coupling body 1. The internal thread 19 commences at one opening of the nut 2 and extends inwardly to a taper 10 near the far end From the taper 10 to the other open end there is a cylindrical section 21. Instead of a coupling body 1 a T-body 1.1 shown in FIG. 6 and having three openings; or even a cross (not illustrated) having four openings may be used. Each branch has an external thread 14 and spigot 11 with taper 12 and flattened nose 13.

The manner in which the invention operates can be best seen in FIG. 7. A pipe 7 is fed through nut 2 and pushed up against stop 22. At 17 a nut is shown before it has been screwed onto the T-body 1.1. At 16 the nut is shown in compressed condition i.e. after it has been screwed on and tightened. As the spigot 11 approaches the far end of the nut 2 its taper 12 engages the taper 10 and it is deflected inwards. The 90° nose section 13 “bites” into the pipe 7 and grips it.

The tapered section 12 on the spigot 11 may be 70° while the taper 10 on the nut 2 may be 45°. This arrangement greatly brings down the torque levels required to tighten the nut 2. As the nut 2 is tightened the taper 12 deforms against the taper 10 of the nut and takes up a 45° angle against the taper of the nut. As this happens the sealing effect takes place and the pipe does not rotate as the nut 2 is being tightened. If the pipe needs to be rotated after this, it is necessary first to loosen the nut 2 and to rotate the pipe by hand or with a suitable tool. Due to the 90° nose section the square section almost immediately bites into the pipe. This also prevents the pipe being shaved off by the harder material.

Should a leak occur, there is only one possible direction for water to escape. This is along the pipe between the pipe and the body past the depression 18 on the pipe and past the nut 2 as indicated by arrow 15.

It is also possible to vary the profile of the spigot 11 without detracting from the invention. For example instead of a taper 12 and a truncated section 13 the profile may be a curve (not illustrated).

This feature is a considerable improvement over the earlier invention. A further advantage is that there is a considerable saving in material needed to make pipe fittings according to this invention when compared to conventional fittings and fittings according to the earlier invention.

It is to be understood that the nut and body together constitute a pipe fitting.

### Industrial Application

Pipe fittings according to the invention will have countless applications in the domestic, industrial, commercial and agricultural sectors.

1. A pipe fitting comprising a body and a nut, the body having at least one sleeve adapted to snugly receive a pipe end and provided with external threading and a spigot, the spigot having at its leading end a truncated nose section and an external partly tapered forward section, the angle of the extenal taper on the forward section of the spigot being between 50° and 80° to a transverse section through the sleeve and the nut having internal threading which matches the external threading on the sleeve and an internal taper at the far end of the threading, the angle of the internal taper on the nut being at least 10° less than that of the external taper and in the range of 50° to 30° to a transvers section through the nut, the arrangement of the forward section, tapers and threading being such that when the sleeve and the nut arc screwed together the forward section of the spigot comes into contact with the internal taper of the nut and is deflected inwardly to grip and seal a pipe end which is in the sleeve.

2. A pipe fitting as claimed in claim 1 in which the angle of the external taper on the front section of the spigot is 70° leading to a nose section of 90° and the internal taper on the nut is 45°.

3. A pipe fitting as claimed in any of the preceding claims in which the body is a coupling.

4. A pipe fitting as claimed in any of claims 1 to 3 in which the body is a tec.

5. A pipe fitting as claimed in any of claims 1 to 3 in which the body is a bend.

6. A pipe fitting as claimed in any of claims 1 to 3 in which the body is a cross.

7. A method of joining pipes in which a pipe is inserted into a pipe fitting as claimed in any of the preceding claims, and the sleeve and nut are screwed together.
